(19) United States
(12) Patent Application Publication
(10) Pub. No.: US 2022/0396234 A1
(43) Pub. Date: Dec. 15, 2022

(54) AIRBAG DEVICE

(71) Applicant: TOYODA GOSEI CO., LTD., Kiyosu-shi (JP)

(72) Inventors: Makoto OZEKI, Kiyosu-shi (JP); Akira YASUDA, Kiyosu-shi (JP); Taizo SUEMITSU, Kiyosu-shi (JP)

(21) Appl. No.: 17/827,038

(22) Filed: May 27, 2022

(30) Foreign Application Priority Data
Jun. 9, 2021 (JP) 2021-96932

(51) Int. Cl. B60R 21/36

(52) U.S. Cl. CPC B60R 21/36

(57) ABSTRACT

An airbag device is such that an inflator has an inflator main body of an approximately cylindrical form, and is coupled to a housing region together with an airbag and an inner tube by, in a state inserted into an interior of the airbag through an insertion aperture formed in the airbag in a state wherein an outer peripheral side of the inflator main body is covered with an inner tube of an approximately tubular form, an attachment member protruding from the inflator main body being caused to protrude from the airbag in a peripheral edge of the insertion aperture and coupled to the housing region. The inner tube includes a tube main body that has a gas outflow port, and a winding fabric that is wound around an outer peripheral side of the tube main body in such a way that a state wherein the tube main body is wound around the outer peripheral side of the inflator main body can be maintained.

### CROSS REFERENCE TO RELATED APPLICATIONS

The present application claims priority from Japanese Patent Application No. 2021-96932 of Ozeki et al., filed on Jun. 9, 2021, the entire disclosures of which is incorporated herein by reference.

### BACKGROUND

### 1. Technical Field

The present disclosure relates to an airbag device of a configuration having an airbag and an inflator inserted into an interior of the airbag, wherein the folded airbag and the inflator are housed in a housing region.

### 2. Description of Related Art

As an existing airbag device of this kind of configuration, there is an airbag device shown in JP-A-2019-172170. In the existing airbag device, an inner tube for causing a flow of an inflating gas to be rectified is disposed on an outer peripheral side of an inflator configured in such a way that an attachment member is caused to protrude from an inflator main body of an approximately cylindrical form, and the inflator is inserted into an interior of an airbag through an insertion aperture formed in the airbag in a state wherein the outer peripheral side is covered by the inner tube. Specifically, in the existing airbag device, the insertion aperture for causing the inflator to be inserted is formed in a slit form in the airbag, and the inflator is of a configuration wherein the attachment member is caused to protrude from the airbag in a peripheral edge of the insertion aperture in a state wherein the inflator is inserted in the interior of the airbag.

An airbag device of this kind of configuration is such that in terms of restricting a gas leakage from the airbag when inflation is completed as far as possible, a size (a slit length) of the insertion aperture is preferably reduced as far as possible. Further, in order to insert the inflator into the insertion aperture set to be as small as possible in a state wherein the outer peripheral side is covered by the inner tube, the inner tube is inserted through the insertion aperture together with the inflator in a state wherein the inner tube is folded compactly on the outer peripheral side of the inflator. Also, the inflator is of a configuration wherein the attachment member protruding from the inflator main body is caused to protrude from the airbag in the peripheral edge of the insertion aperture, and the attachment member protruding from the airbag is coupled to a housing region. Because of this, there is a demand for restricting an occurrence of the inner tube becoming jammed in a peripheral edge region of the attachment member, or the like, when coupling to the housing region. The existing airbag device is such that there is room for improvement in terms of preventing this kind of jamming, and smoothly disposing the inflator in the airbag in a state wherein the outer peripheral side is covered by the inner tube.

### SUMMARY

The present disclosure relates to an airbag device of the following configuration.

The airbag device includes an airbag, an inflator that can supply an inflating gas to the airbag, a housing region in which the folded airbag and the inflator are housed, and an inner tube that covers an outer peripheral side of the inflator in the airbag. The inflator includes an inflator main body of an approximately cylindrical form and an attachment member, disposed in such a way as to protrude from the inflator main body, for attaching the inflator to the housing region, and is of a configuration coupled to the housing region together with the airbag and the inner tube by, in a state inserted into an interior of the airbag through an insertion aperture formed in the airbag in a state wherein an outer peripheral side of at least a part (one portion) of the inflator main body is covered with the inner tube, the attachment member being caused to protrude from the airbag in a peripheral edge of the insertion aperture and coupled to the housing region. The inner tube is configured of a sheet material having flexibility, and includes a tube main body, of a configuration covering the outer peripheral side of the inflator main body, that has a gas outflow port that can cause the inflating gas to flow out rectified, and a winding fabric, configured in such a way that a width dimension is approximately the same as that of the tube main body, that is wound around an outer peripheral side of the tube main body in such a way that a state wherein the tube main body is wound around the outer peripheral side of the inflator main body can be maintained when an operation of inserting inside the airbag is carried out. The winding fabric is disposed in such a way that when the inflating gas is discharged from the inflator main body, a winding around the outer peripheral side of the tube main body is terminated and can be unwound so that the gas outflow port is caused to open while the tube main body is caused to be detached from the attachment member side.

### BRIEF DESCRIPTION OF DRAWINGS

FIG. 1 is a plan view of a vehicle in which a pedestrian airbag device that is one embodiment of the present disclosure is mounted;

FIG. 2 is a schematic vertical sectional view following a front-rear direction of the pedestrian airbag device of the embodiment, and shows a region of an inflator;

FIG. 3 is a schematic vertical sectional view following the front-rear direction of the pedestrian airbag device of the embodiment, and shows a region of an attachment bracket;

FIG. 4 is a schematic vertical sectional view following a left-right direction showing a region of the inflator in the pedestrian airbag device of the embodiment;

FIG. 5 is a plan view of an airbag used in the pedestrian airbag device of the embodiment in a state wherein the airbag is flat;

FIG. 6 is a bottom view of the airbag of FIG. 5 in a state wherein the airbag is flat;

FIG. 7 is a partially enlarged bottom view showing an insertion aperture portion in the airbag of FIG. 5;

FIG. 8 is a plan view wherein base materials configuring the airbag of FIG. 5 and an inner tube are aligned;

FIG. 9 is a plan view of a state wherein a tube main body and a winding fabric are aligned in the inner tube used in the pedestrian airbag device of the embodiment;

FIG. 10A is a plan view showing a state before a temporary joining of the tube main body and the winding fabric by a temporary fastening tab in the inner tube of FIG. 9, and FIG. 10B is a plan view showing a state after a temporary joining of the tube main body and the winding fabric by the temporary fastening tab;

FIG. 11 is a sectional view of an XI-XI region in FIG. 10A;

FIG. 12 is a sectional view of an XII-XII region in FIG. 10A;

FIG. 13 is a partially enlarged plan view of a region of the temporary fastening tab in the inner tube of FIG. 9;

FIGS. 14A and 14B are schematic sectional views illustrating a process of winding the inner tube around an outer peripheral side of the inflator in the pedestrian airbag device of the embodiment;

FIG. 15 is a schematic plan view of a state wherein inflation of the airbag is completed in the pedestrian airbag device of the embodiment;

FIG. 16 is a schematic vertical sectional view of a state wherein inflation of the airbag is completed in the pedestrian airbag device of the embodiment;

FIG. 17 is a plan view of an inner tube that is another aspect of the present disclosure; and

FIGS. 18A, 18B, and 18C are schematic sectional views illustrating a process of winding the inner tube of FIG. 17 around the outer peripheral side of the inflator.

### DETAILED DESCRIPTION

Exemplary embodiments of the present disclosure are described below with reference to the accompanying drawings. However, the invention is not limited to the embodiments disclosed herein. All modifications within the appended claims and equivalents relative thereto are intended to be encompassed in the scope of the claims.

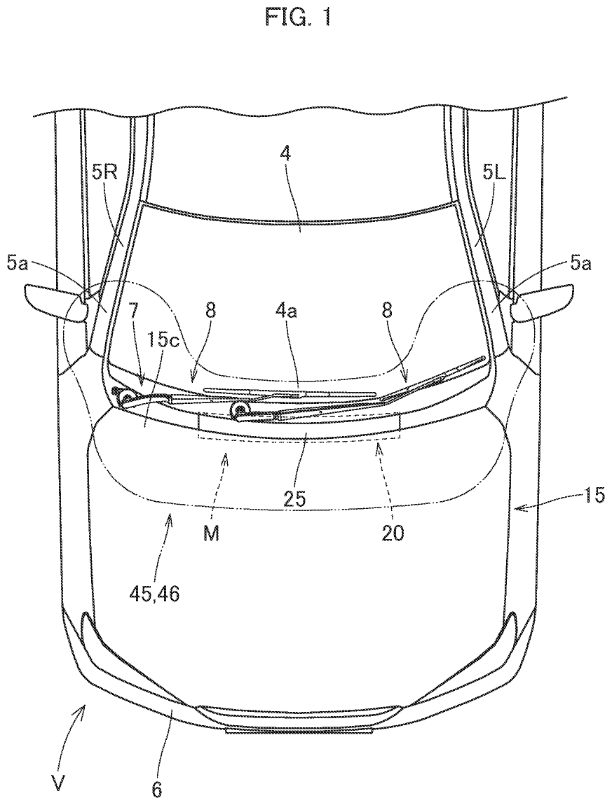

Hereafter, an embodiment of the present disclosure will be described, based on the drawings. In the embodiment, the description will be given employing a pedestrian airbag device M mounted in a vicinity of a rear end 15c of a hood panel 15 of a vehicle V as an example of an airbag device. As shown in FIGS. 1 to 4, the pedestrian airbag device (hereafter abbreviated as “airbag device”) M is disposed in a position that is a position in proximity to the rear end 15c of the hood panel 15, in an approximate center in a left-right direction of the vehicle V between left and right front pillars 5L and 5R. In the specification, a description is given with front-rear, up-down, and left-right directions coinciding with front-rear, up-down, and left-right directions of the vehicle V, unless stated otherwise.

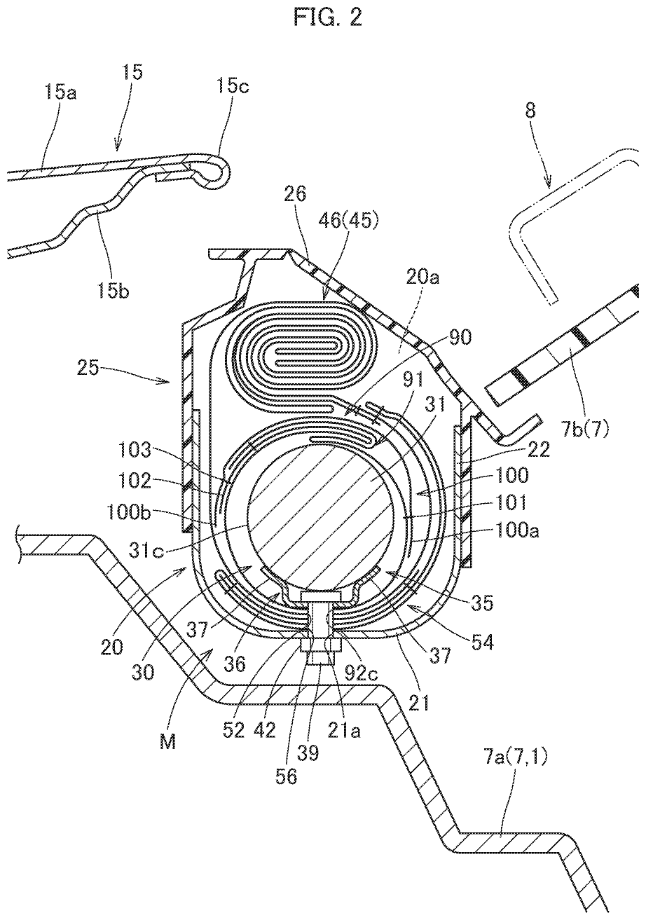

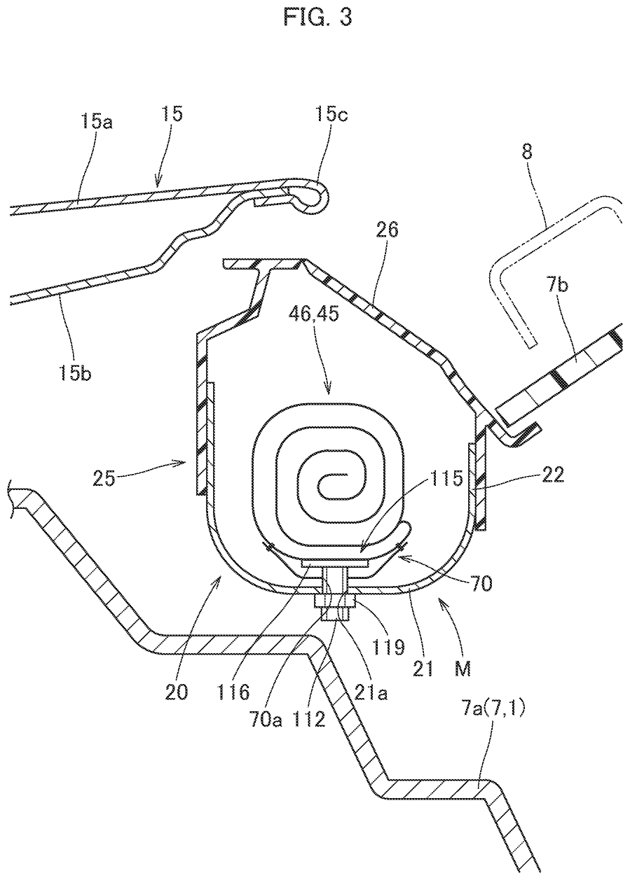

As shown in FIG. 1, the hood panel 15 is disposed in such a way as to cover an engine room of the vehicle V from above. The hood panel 15 is coupled to a body 1 side of the vehicle V by an unshown hinge portion disposed in a vicinity of the rear end 15c on both left and right edge sides in such a way as to be openable and closable from the front. In the case of the embodiment, the hood panel 15 is formed of a steel plate or a sheet material of aluminum (an aluminum alloy) or the like, and includes an outer panel 15a and an inner panel 15b, as shown in FIGS. 2 and 3. As shown in FIG. 1, the rear end 15c side of the hood panel 15 is caused to curve in the left-right direction in such a way that a left-right direction center is positioned to the front and both left-right direction end sides are positioned to the rear, in order to coincide with a front windshield 4 to be described hereafter.

As shown in FIGS. 2, 3, and 16, a cowl 7 formed of a cowl panel 7a of a high rigidity on the body 1 side and a cowl louver 7b made from a synthetic resin above the cowl panel 7a is disposed to the rear of the hood panel 15. The cowl louver 7b is disposed in such a way that a rear end side is continuous with a lower portion 4a side of the front windshield 4. The cowl 7 is also formed to be curved in order to coincide with the curved form of the rear end 15c of the hood panel 15 (refer to FIG. 1). Also, two wipers 8 are disposed in a region of the cowl 7, as shown in FIG. 1. The wipers 8 are disposed in such a way as to protrude upward from the cowl louver 7b, as indicated by a two-dot chain line in FIGS. 2, 3, and 16. The front pillars 5L and 5R are disposed outward of the front windshield 4 on the left and right.

As shown in FIGS. 1 to 4, the airbag device M includes an airbag 45, an inflator 30 that supplies an inflating gas to the airbag 45, an inner tube 90 that covers an outer peripheral side of the inflator 30 in the airbag 45, a case 20 (a housing region) that houses the folded airbag 45 and the inflator 30, an airbag cover 25 that covers the folded airbag 45, and attachment brackets 115 that attach attachment piece portions 70, to be described hereafter, of the airbag 45 to the case 20.

The case 20 acting as a housing region is made of sheet metal, and is of an approximate box form including a bottom wall portion 21 and a peripheral wall portion 22 of an approximately rectangular tube form extending upward from the bottom wall portion 21 and having an opened upper end side, as shown in FIGS. 2 and 3. The case 20 is of a configuration wherein the inflating airbag 45 is caused to protrude from a protrusion aperture 20a on the upper end side. A multiple of attachment holes 21a are formed in the bottom wall portion 21 (refer to FIGS. 2 to 4). Attachment bolts 39 that attach the inflator 30 and attachment bolts 117 that attach the attachment piece portion 70 of the airbag 45 are inserted through the attachment holes 21a, and attached to the bottom wall portion 21 by fastening nuts 42 and 119. In the case of the embodiment, the case 20 is disposed in such a way that a front side region is positioned immediately below the rear end 15c of the hood panel 15, and a rear side region is positioned farther to the rear side than the hood panel 15. The case 20 is attached to the cowl panel 7a on the body 1 side using an unshown bracket.

The airbag cover 25 is made from a soft synthetic resin such as a polyolefin-based thermoplastic elastomer (TPO). The airbag cover 25 is disposed in such a way as to cover the protrusion aperture 20a on the upper end side of the case 20, and has a door portion 26 that can open toward the rear side by being pushed by the airbag 45 when the airbag 45 becomes inflated (refer to FIGS. 2, 3, and 16). The airbag cover 25 is such that a predetermined place is attached to the case 20 using an unshown attachment member.

The inflator 30 includes an inflator main body 31 and an attachment bracket 35 for attaching the inflator main body 31 to the case 20.

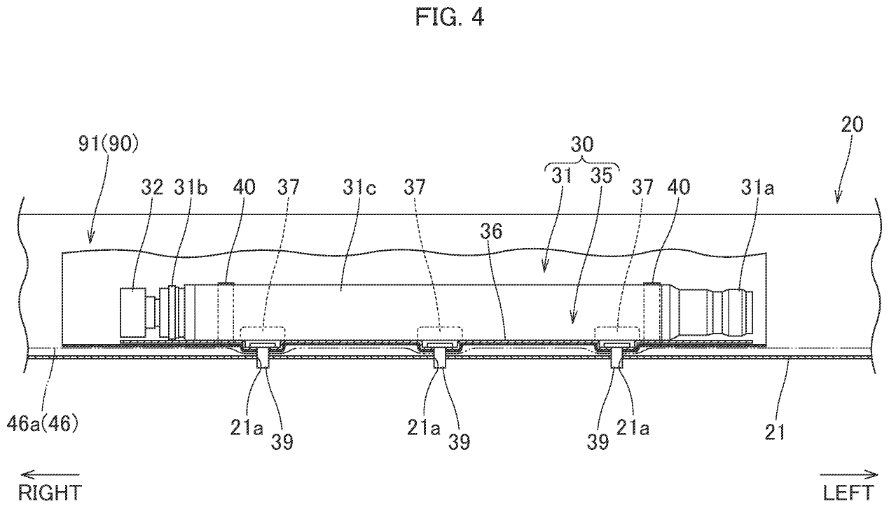

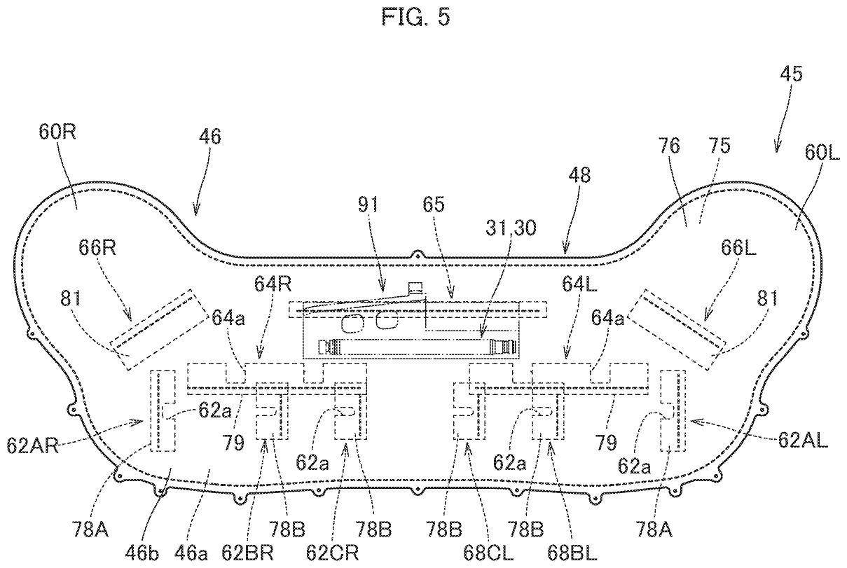

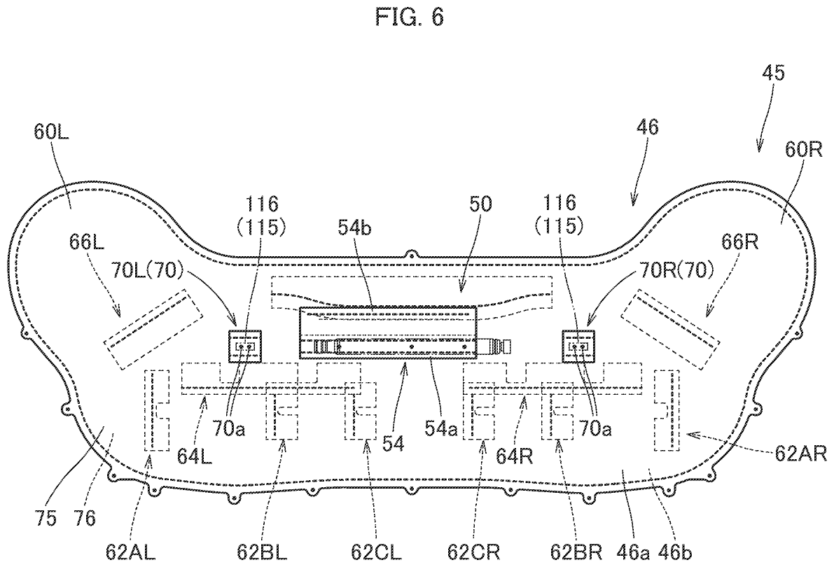

An external form of the inflator main body 31 is approximately cylindrical. The inflator main body 31 is disposed in an interior in a position in an approximate front-rear and left-right center of a cowl cover portion 48, to be described hereafter, in the airbag 45, in such a way as to approximately follow an axial direction in the left-right direction, as shown in FIGS. 2 and 4. Specifically, the inflator main body 31 is disposed in a position slightly farther to the rear than a front-rear center of the cowl cover portion 48 (refer to a two-dot chain line in FIGS. 5 and 6). As shown in FIG. 4, a gas discharging unit 32 that can discharge an inflating gas G is disposed on one end side (a right end 31b side in the case of the embodiment) in an axial direction of the inflator main body 31. An unshown lead is disposed on another end side (a left end 31a side) in the axial direction of the inflator main body 31. Further, the inflator main body 31 is electrically connected to an unshown operation circuit via the lead. When detecting a collision between the vehicle V and a pedestrian based on a signal from a sensor, the operation circuit causes the inflator main body 31 to operate.

As shown in FIGS. 2 and 4, the attachment bracket 35 for attaching the inflator main body 31 to the case 20 includes a holding portion 36, which holds the inflator main body 31, and a multiple (three in the case of the embodiment) of the attachment bolt 39 protruding downward from the holding portion 36. The holding portion 36 is made from sheet metal, and is of a strip form extending to approximately follow the left-right direction (the axial direction of the inflator main body 31) in such a way as to support a lower face side of the inflator main body 31. A supporting piece portion 37 that supports the inflator main body 31 is formed in such a way as to protrude on both front and rear sides in a multiple of places (three places in the case of the embodiment) following the left-right direction in the holding portion 36. Each supporting piece portion 37 is formed inclined in such a way that leading ends extend toward an upper side, while heading outward front and rear, from front and rear edge portions of the holding portion 36, in such a way as to be able to support an outer peripheral face of the inflator main body 31. Each supporting piece portion 37 is symmetrical in the front-rear direction (refer to FIG. 2). In the case of the embodiment, the supporting piece portions 37 are formed in positions corresponding to the attachment bolts 39, as shown in FIG. 4. The attachment bolts 39 are formed in such a way as to protrude downward one each in three places, those being both left and right end sides and an approximate left-right center of the holding portion 36. Further, in the embodiment, the attachment bracket 35 is of a configuration such that, in a state wherein the inflator main body 31 is caused to be held in the holding portion 36, the inflator main body 31 is attached by a clamp 40 being wound around from an outer peripheral side. In the case of the embodiment, the clamp 40 is disposed in two places on left and right end sides of the holding portion 36 (refer to FIG. 4).

That is, as shown in FIGS. 3 and 4, in the inflator 30 of the embodiment, each of the attachment bolt 39 acting as an attachment member is disposed in such a way as to protrude from an outer peripheral face 31c of the inflator main body 31 in a direction perpendicular to an axis of the inflator main body 31 (downward). Further, the inflator 30 is of a configuration wherein the inflator main body 31 and the holding portion 36 in the attachment bracket 35 are attached to the bottom wall portion 21 of the case 20 in a state inserted into the interior of the airbag 45 in such a way that the attachment bolts 39 are caused to protrude to an exterior from an insertion hole 52 and an attachment hole 56, to be described hereafter. At this time, the inflator 30 is such that the inflator main body 31 is attached to the attachment bracket 35 using the clamps 40, and the outer peripheral side is covered with the inner tube 90 in such a way as to cause the attachment bolts 39 to protrude from an insertion holes 92c. Specifically, the inflator 30 is of a configuration attached to the case 20, together with the airbag 45, by each attachment bolt 39 protruding from a cover panel 54, to be described hereafter, in the airbag 45 being caused to protrude from the bottom wall portion 21 of the case 20 and fastened with the nut 42 (refer to FIG. 2). Also, in the embodiment, the inflator 30 is of a configuration housed in the airbag 45 in a state wherein outer peripheral sides of the inflator main body 31 and the holding portion 36 in the attachment bracket 35 are covered with the inner tube 90. That is, a configuration is such that when the inflator 30 is attached to the case 20, the inner tube 90 is also coupled to the case 20 in addition to the airbag 45. Further, in the case of the embodiment, the inflator 30 (the inflator main body 31) is housed in a position slightly farther to the rear side than the front-rear center of the cowl cover portion 48 in the airbag 45 by an axial direction center being caused to approximately coincide with a left-right center of the airbag 45 (a bag main body 46) (refer to FIGS. 5 and 6). More specifically still, the inflator 30 (the inflator main body 31) is housed in the cowl cover portion 48 by the right end 31b side on which the gas discharging unit 32 is disposed being positioned farther to the right than the cover panel 54 (that is, farther to the right than an insertion slit 51 to be described hereafter), and the left end 31a side being positioned farther to the right than a left edge of the cover panel 54.

As shown in FIGS. 5 to 7, the airbag 45 includes the bag main body 46, which inflates owing to an inflating gas being caused to flow into an interior, tethers 62AL, 62BL, 62CL, 62AR, 62BR, 62CR, 64L, 64R, 65, 66L, and 66R, which regulate a thickness of the main bag 46 when inflation is completed, and the attachment piece portions 70 (70L, 70R), which attach a vehicle body side wall portion 46a side, to be described hereafter, of the bag main body 46 to the case 20. Also, the bag main body 46 has an insertion aperture portion 50 for causing the inflator 30 to be inserted in the interior.

An external form of the bag main body 46 when inflation is completed is an approximate U-form wide in a left-right direction as seen from the front side. The bag main body 46 includes the cowl cover portion 48, which is disposed approximately following the left-right direction in such a way as to approximately follow the lower portion 4a of the front windshield 4, and pillar cover portions 60L and 60R, which extend rearward one each from either end of the cowl cover portion 48 and cover lower portion 5a sides of front faces of the left and right front pillars 5L and 5R. Also, the bag main body 46 has the vehicle body side wall portion 46a, which is disposed on the body 1 side when inflation is completed, and a pedestrian side wall portion 46b disposed opposing the vehicle body side wall portion 46a, and is of a bag form owing to outer peripheral edges of the vehicle body side wall portion 46a and the pedestrian side wall portion 46b being joined to each other (sewn together) over a whole periphery.

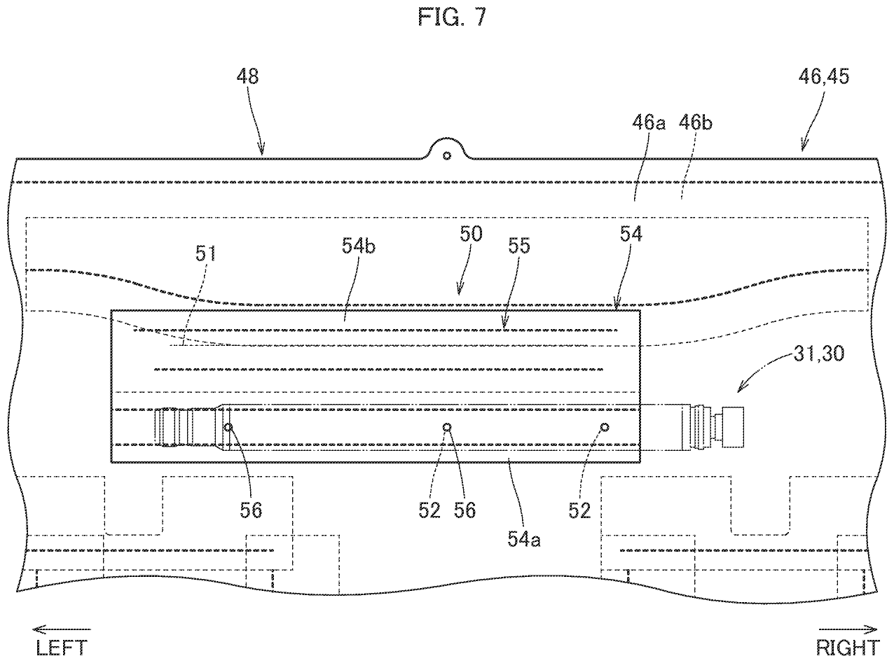

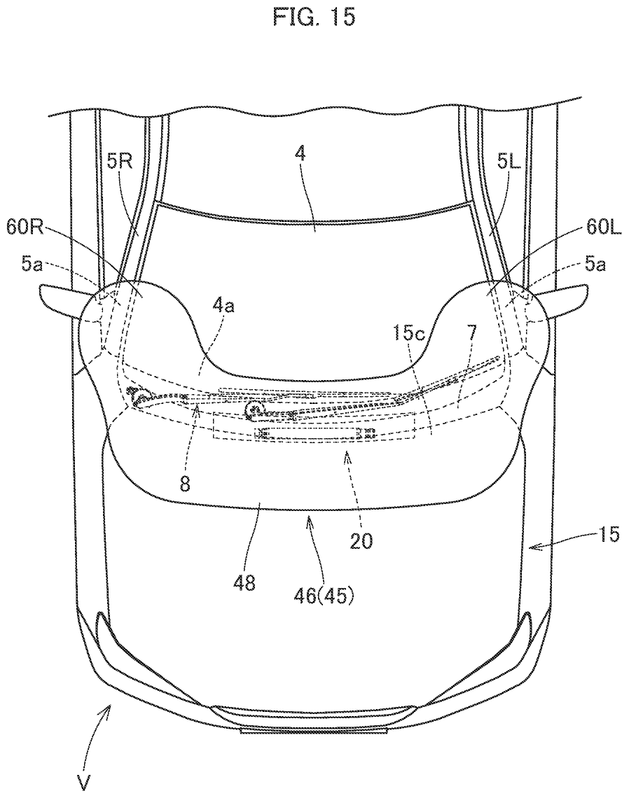

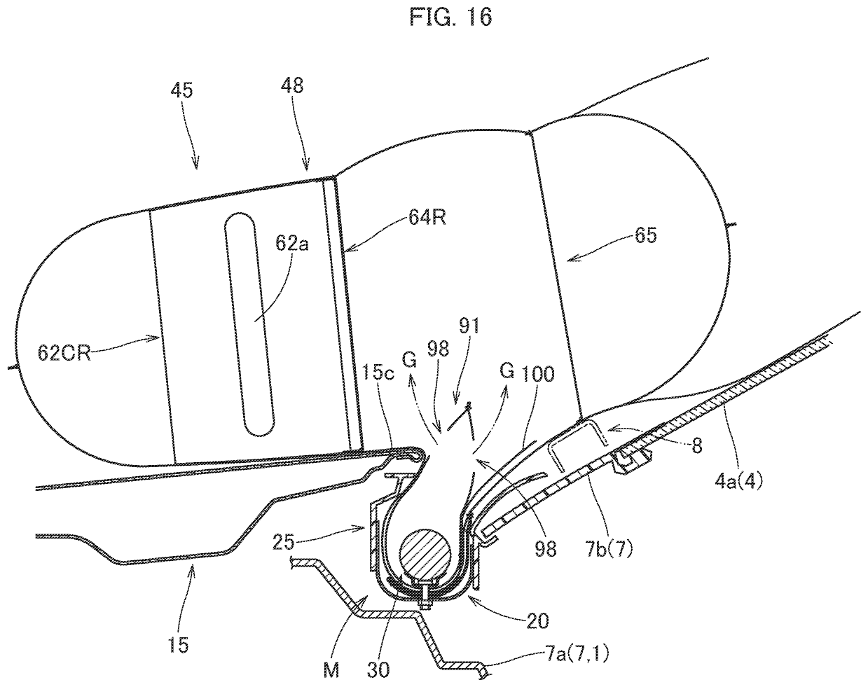

The cowl cover portion 48 is a region that covers an upper face side of a region from the rear end 15c of the hood panel 15 to the cowl 7 when inflation is completed. Specifically, in the case of the embodiment, the cowl cover portion 48 is configured in such a way as to cover an upper face side (front face side) of a region from a region on the rear end 15c side of the hood panel 15, via the cowl 7, to the lower portion 4a side of the front windshield 4 over an approximate whole area in a vehicle width direction (left-right direction), including also the wipers 8, when inflation is completed (refer to FIGS. 15 and 16). The airbag 45 of the embodiment is of a configuration such that the inflator 30 is housed in a position in an approximate front-rear and left-right center of the cowl cover portion 48. Further, a region in the approximate front-rear and left-right center of the cowl cover portion 48 in the vehicle body side wall portion 46a configures the insertion aperture portion 50 for causing the inflator 30 to be inserted into the interior (refer to FIGS. 6 and 7).

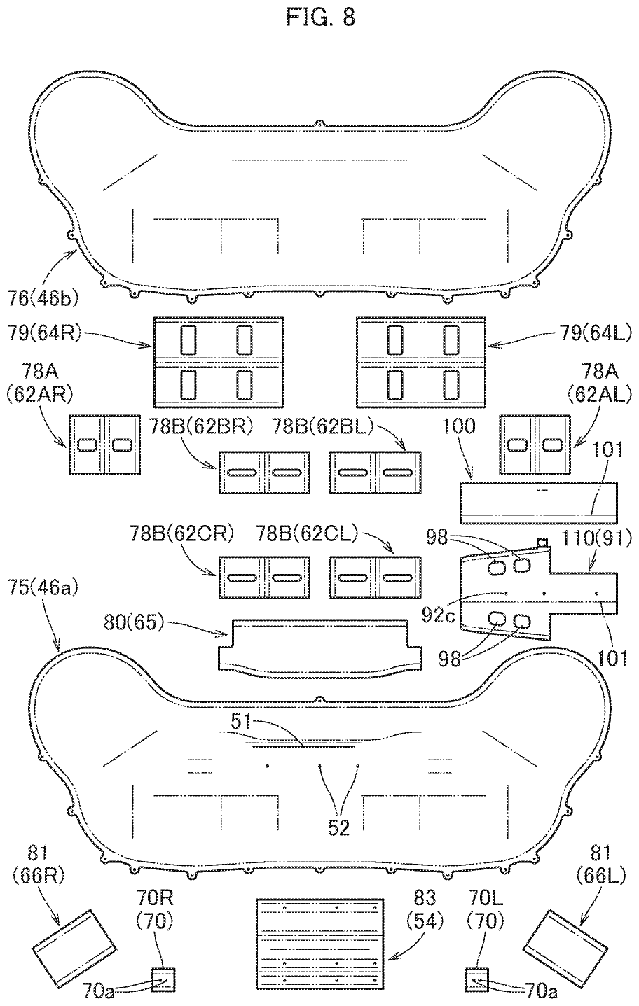

Specifically, the inflator 30 is housed in a position slightly farther to the rear side than the front-rear center of the cowl cover portion 48, and the insertion aperture portion 50 is also disposed in a position slightly farther to the rear side than the front-rear center of the cowl cover portion 48. Specifically, the insertion aperture portion 50 is disposed in a region between the front side left-right tethers 64L and 64R and the rear side left-right tether 65, to be described hereafter, in the vehicle body side wall portion 46a. As shown in FIG. 7, the insertion aperture portion 50 includes the insertion slit 51 acting as an insertion aperture, the insertion holes 52, through which the attachment bolts 39 (the attachment member) of the inflator 30 are caused to protrude, and the cover panel 54, which blocks off the insertion slit 51 from an outer peripheral side. The insertion slit 51 acting as an insertion aperture is for inserting the inflator 30 (the inflator main body 31), and is formed in a linear form approximately following the left-right direction in such a way as to approximately follow the axial direction of the inflator main body 31. A length dimension of the insertion slit 51 is set to be smaller than a length dimension of the inflator main body 31 (refer to FIG. 7) in order that the inflator main body 31 can be inserted, and in order that gas leakage can be restricted. Each of the insertion hole 52 is for causing the attachment bolt 39 of the inflator 30 to protrude, and is formed in a position in a peripheral edge of the insertion slit 51, or more specifically, on a front side of the insertion slit 51. The insertion hole 52 is formed in three places following the left-right direction, corresponding to the attachment bolts 39. The cover panel 54 is configured of a separate member formed from a sheet material having flexibility. The cover panel 54 is configured in such a way as to be able to block off the insertion slit 51 on the outer peripheral side of the vehicle body side wall portion 46a, and an external form thereof is an approximately rectangular form wherein a left-right direction side is wider. A rear end 54b side of the cover panel 54 is joined to the vehicle body side wall portion 46a by a joining region 55 formed continuously over an approximate whole left-right area in a position on the rear side of the insertion slit 51. The attachment holes 56 for causing the attachment bolts 39 of the inflator 30 to protrude are disposed corresponding to the insertion holes 52 on a front end 54a side of the cover panel 54. In the case of the embodiment, the cover panel 54 is formed from a kind of cover panel base fabric 83 shown in FIG. 8.

In the case of the embodiment, the front-rear tethers 62AL, 62BL, 62CL, 62AR, 62BR, and 62CR, the front side left-right tethers 64L and 64R, the rear side left-right tether 65, and the end side tethers 66L and 66R are disposed as tethers regulating the thickness of the bag main body 46 when inflation is completed in the bag main body 46.

The front-rear tethers 62AL, 62BL, 62CL, 62AR, 62BR, and 62CR, the front side left-right tethers 64L and 64R, the rear side left-right tether 65, and the end side tethers 66L and 66R couple the pedestrian side wall portion 46b and the vehicle body side wall portion 46a, and regulate the distance of separation between the pedestrian side wall portion 46b and the vehicle body side wall portion 46a when inflation is completed (refer to FIG. 16). The front side left-right tethers 64L and 64R are disposed in positions slightly farther to the front than the front-rear center of the cowl cover portion 48, in such a way as to approximately follow the left-right direction on the front side of the insertion aperture portion 50. The rear side left-right tether 65 is disposed in such a way as to approximately follow the left-right direction on the rear side of the insertion aperture portion 50. The front-rear tethers 62AL, 62BL, 62CL, 62AR, 62BR, and 62CR are disposed in one place in a position outward in the left-right direction from each of the front side left-right tethers 64L and 64R, and in two places on the front side of each of the front side left-right tethers 64L and 64R. The front-rear tethers 62AL, 62BL, 62CL, 62AR, 62BR, and 62CR are juxtaposed on the left-right direction side in such a way that each approximately follows the front-rear direction. In order that the front-rear tethers 62AL and 62AR disposed outward in the left-right direction from the front side left-right tethers 64L and 64R extend farther to the rear than the front side left-right tethers 64L and 64R, a width dimension thereof is set to be greater than that of the remaining front-rear tethers 62BL, 62CL, 62BR, and 62CR. In the case of the embodiment, an aperture portion 64a opened in such a way that an inflating gas can circulate is formed in the front side left-right tethers 64L and 64R. Also, an aperture portion 62a opened in such a way that an inflating gas can circulate is formed in the front-rear tethers 62AL, 62BL, 62CL, 62AR, 62BR, and 62CR (refer to FIGS. 5 and 16). One aperture portion 62a is formed in a long hole form approximately following the up-down direction in each front-rear tether 62AL, 62BL, 62CL, 62AR, 62BR, and 62CR. Two aperture portions 64a are formed in a long hole form approximately following the up-down direction in each front side left-right tether 64L and 64R. The end side tethers 66L and 66R are disposed inclined with respect to the left-right direction in such a way that left and right inner sides are positioned to the rear in vicinities of boundary regions between the cowl cover portion 48 and the pillar cover portions 60L and 60R respectively. The front-rear tethers 62AL, 62BL, 62CL, 62AR, 62BR, and 62CR,the front side left-right tethers 64L and 64R, the rear side left-right tether 65, and the end side tethers 66L and 66R are disposed to have bilateral symmetry in the bag main body 46.

The attachment piece portions 70 that attach the vehicle body side wall portion 46a side of the bag main body 46 to the case 20 are disposed on both left and right sides of the insertion aperture portion 50. Each of the attachment piece portion 70 is configured of a sheet material having flexibility separately from the bag main body 46, and a front end side and a rear end side are joined (sewn to) the vehicle body side wall portion 46a, as shown in FIGS. 3 and 6. Each of the attachment piece portion 70 (70L, 70R) is of a configuration attached to the bottom wall portion 21 of the case 20 using an attachment bracket 115. In the case of the embodiment, the attachment piece portion 70 (70L, 70R) is disposed in two places having approximate bilateral symmetry between the insertion aperture portion 50 and the end side tethers 66L and 66R, and to the rear side of the front side left-right tethers 64L and 64R, in a state wherein the bag main body 46 is flat, as shown in FIG. 6. Each of the attachment piece portion 70 (70L, 70R) is for inserting an attachment plate 116, to be described hereafter, of the attachment bracket 115 between the attachment piece portion 70 and the vehicle body side wall portion 46a (refer to FIG. 3), and has two through holes 70a through which the attachment bolts 117, to be described hereafter, formed in the attachment bracket 115 can be inserted.

As shown in FIG. 8, the airbag 45 of the embodiment is configured of a vehicle body side base fabric 75 configuring the vehicle body side wall portion 46a and a pedestrian side base fabric 76 configuring the pedestrian side wall portion 46b in the bag main body 46, tether base fabrics 78A, 78B, 79, 80, and 81 configuring the front-rear tethers 62AL, 62BL, 62CL, 62AR, 62BR, and 62CR, the front side left-right tethers 64L and 64R, the rear side left-right tether 65, and the end side tethers 66L and 66R respectively, the cover panel base fabric 83 configuring the cover panel 54, and the attachment piece portions 70. The airbag 45 is configured of a coated fabric wherein a gas leak-preventing coating agent is applied to a surface of a woven fabric formed by weaving a polyamide-based material, a polyester-based material, or the like. Further, the base fabrics (base materials) are formed by this kind of coated fabric being cut into a predetermined form.

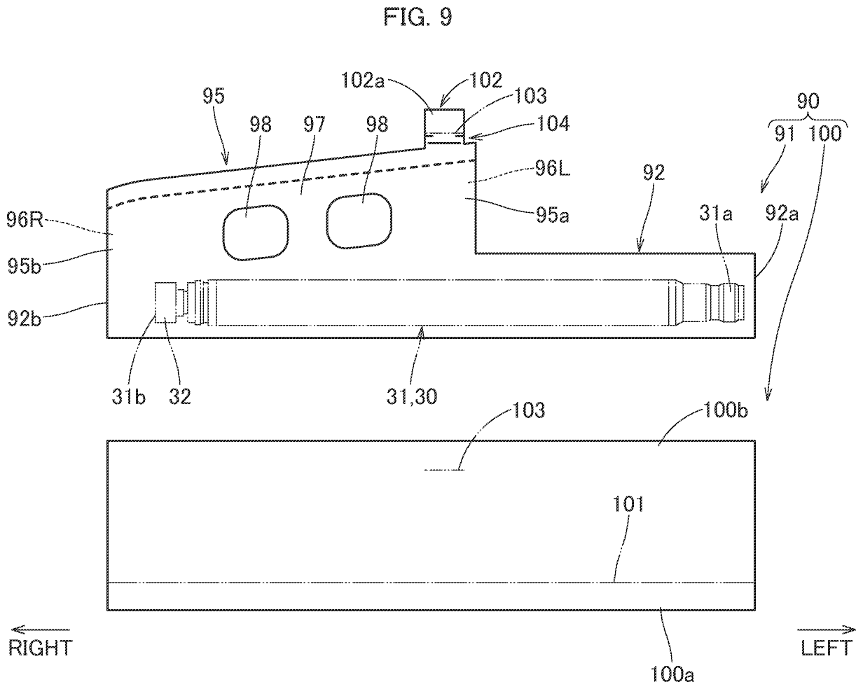

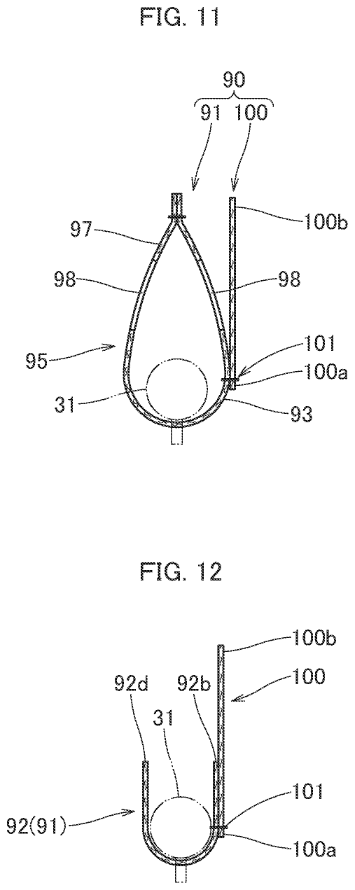

In the case of the embodiment, as shown in FIGS. 9 to 11, the inner tube 90 covering the outer peripheral side of the inflator 30 includes a tube main body 91, a winding fabric 100, and a temporary fastening tab 102 that causes the tube main body 91 and the winding fabric 100 to be coupled. The inner tube 90 is configured of a sheet material having flexibility. In the same way as the airbag 45, the inner tube 90 is configured of a coated fabric wherein a gas leak-preventing coating agent is applied to a surface of a woven fabric formed by weaving a polyamide-based material, a polyester-based material, or the like, in the case of the embodiment.

The tube main body 91 is of an approximately tubular form that covers the outer peripheral side of the inflator main body 31 (specifically, the inflator main body 31 and the holding portion 36 in the attachment bracket 35). In the case of the embodiment, the tube main body 91 includes an attachment side portion 92 and a gas rectifying portion 95, as shown in FIGS. 9, 11, and 12. The attachment side portion 92 is configured in such a way as to cover the outer peripheral side of the inflator main body 31 and to cause the attachment bolts 39 to protrude. The gas rectifying portion 95 is a region that rectifies the inflating gas G discharged from the inflator main body 31.

The attachment side portion 92 is configured in an approximate strip form whose longitudinal direction follows the axial direction of the inflator main body 31, in such a way as to be able to cover the outer peripheral side of the inflator main body 31. An insertion hole 92c for causing the attachment bolt 39 of the attachment bracket 35 to protrude is disposed in three places following the longitudinal direction in positions in an approximate width direction center of the attachment side portion 92 (refer to FIG. 8).

The attachment side portion 92 is configured in such a way as to be able to cover the outer peripheral side of the inflator main body 31, excepting an upper face side, in a state mounted in a vehicle. A longitudinal direction side (left-right direction side) width dimension of the attachment side portion 92 is set to be greater than the length dimension of the inflator main body 31, whereby the attachment side portion 92 can cover the outer peripheral side of the inflator main body 31 over a whole left-right area (refer to FIG. 9).

The gas rectifying portion 95 is of an approximately tubular form wherein both left and right end sides are opened. Specifically, the gas rectifying portion 95 is of an approximately tubular form and partially protrudes upward from the attachment side portion 92. The gas rectifying portion 95 is formed such that extends from a front edge 92d side and a rear edge 92e side of the attachment side portion 92, and owing to leading ends being joined to each other. The gas rectifying portion 95 is disposed in a right-side region of the attachment side portion 92 in such a way as to cover an outer peripheral side of the gas discharging unit 32 disposed on the right end 31b side in the inflator main body 31. Specifically, the gas rectifying portion 95 is of a tubular form wherein a right end 95b is caused to coincide with a right end 92b of the attachment side portion 92, and a diameter expands toward a left side. Also, the gas rectifying portion 95 is configured to be wider in the left-right direction, in such a way that a left end 95a is disposed in a position slightly to the left of a left-right center of the attachment side portion 92. Also, gas outflow ports 96L and 96R for causing an inflating gas to flow out rectified are formed on the left end 95a side of the gas rectifying portion 95 and the right end 95b side, which coincides with the right end 92b of the attachment side portion 92. As heretofore described, the gas rectifying portion 95 is of an approximately tubular form such that the diameter expands toward the left side, which is a left-right central side. That is, although a detailed depiction is omitted, an aperture area of the left-side gas outflow port 96L is configured to be greater than that of the right-side gas outflow port 96R. Also, the gas rectifying portion 95 also has a gas outflow port 98 that can cause an inflating gas to flow out rectified in a region of a peripheral wall 97. The gas outflow port 98 provided in the peripheral wall 97 opens in an approximately rectangular form, and two are juxtaposed on each of left and right direction sides on both the front and rear sides.

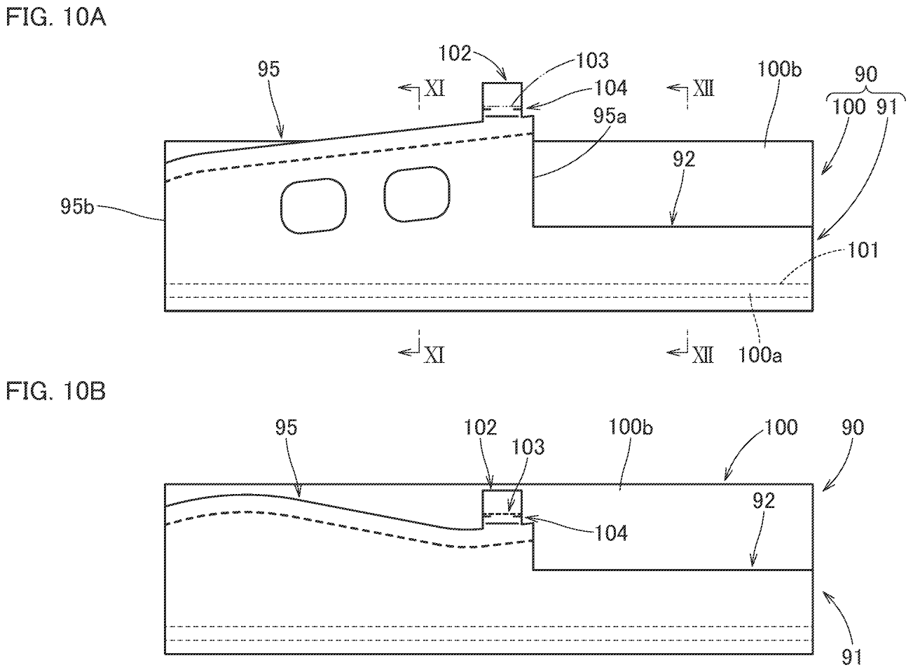

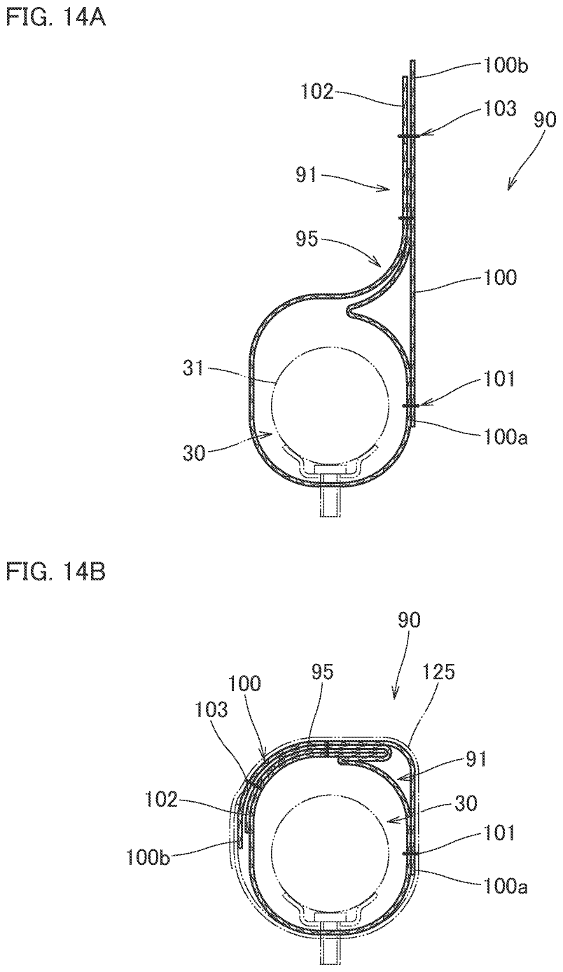

The winding fabric 100 is for maintaining a wound state of the tube main body 91 wound around the outer peripheral side of the inflator main body 31 when the inflator 30 is inserted into the airbag 45. In the case of the embodiment, the winding fabric 100 is disposed in such a way as to extend from the tube main body 91, with a base portion 100a side sewn to (joined to) the tube main body 91, in a state wherein the temporary fastening tab 102 is not joined, and in a state before winding (refer to FIGS. 10 to 12). Specifically, the base portion 100a of the winding fabric 100 is sewn in a position in an up-down intermediate region of a rear side region 93, disposed on a rear side when mounted in a vehicle, in the attachment side portion 92 of the tube main body 91. More specifically still, the base portion 100a of the winding fabric 100 is sewn to the attachment side portion 92 in such a way that a joining region 100 is formed over approximately a whole left-right area. The winding fabric 100 is of an approximately rectangular form whose width dimension (left-right direction side width dimension) is approximately the same as a left-right direction side width dimension of the tube main body 91. Also, a front-rear direction side width dimension of the winding fabric 100 is set to be a dimension such that the winding fabric 100 can cover an outer peripheral side of a region on an upper face side of the tube main body 91 (specifically, an outer peripheral side of the gas rectifying portion 95 and a region on an upper edge side of the attachment side portion 92) when wound around the outer peripheral side of the tube main body 91 (refer to FIG. 14B). More specifically still, the front-rear direction side width dimension of the winding fabric 100 is set to be a width dimension such that a region on the left end 95a side of the gas rectifying portion 95 in the tube main body 91, that is, the temporary fastening tab 102, is caused to protrude farther than a leading end 100b in a state wherein the tube main body 91 and the winding fabric 100 are stacked and flattened in a state before a temporary joining using the temporary fastening tab 102 (refer to FIG. 10A). Further, in a state wherein the temporary fastening tab 102 is joined to the leading end 100b side of the winding fabric 100 in such a way as to form a joining region 103, the gas rectifying portion 95 is disposed in a slack state in order that a region on the left end 95a side is partially contracted, as will be described hereafter (refer to FIGS. 10B and 14A). The leading end 100b of the winding fabric 100 is disposed in a position on the front side of the inflator main body 31 in a state wherein the winding fabric 100 is wound around the outer peripheral side of the inflator 30, in a position approximately opposing a joining region 101 on the base portion 100a side in the front-rear direction (refer to FIG. 14B). In the embodiment, by the winding fabric 100 simply being wound around the outer peripheral side of the inflator 30 in such a way that the leading end 100b is oriented forward, the gas rectifying portion 95 of the tube main body 91 can be disposed in an upper side region when the inflator 30 is mounted in a vehicle.

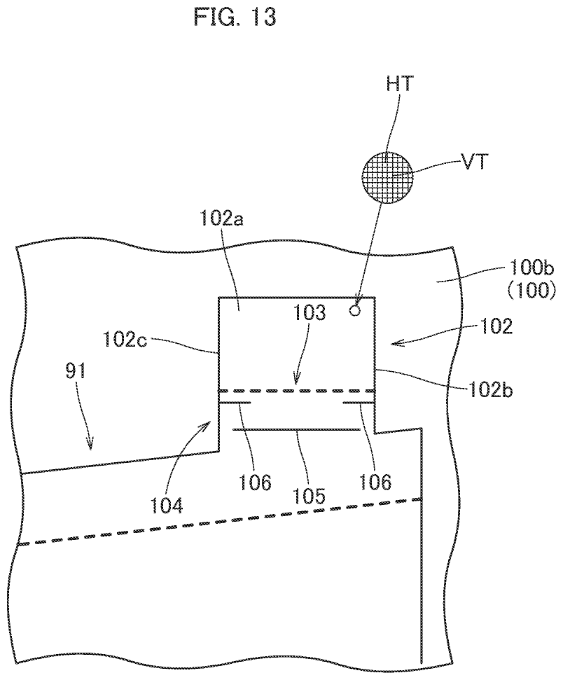

In the case of the embodiment, the temporary fastening tab 102 that causes the tube main body 91 and the winding fabric 100 to be coupled is disposed in such a way as to extend from the tube main body 91 side. Specifically, the temporary fastening tab 102 is disposed in one place on the left end 95a side of the gas rectifying portion 95 in the tube main body 91 in such a way as to extend from the upper face side when mounted in a vehicle (refer to FIGS. 9 and 10). That is, the temporary fastening tab 102 is formed in one place on a left-right central side of the inner tube 90. The temporary fastening tab 102 is of a configuration wherein an external form is an approximately rectangular form, and a leading end 102a side is sewn (joined) to the leading end 100b side (a winding start end side) of the winding fabric 100 using suture thread. Also, the temporary fastening tab 102 is such that a breakable portion 104 that can be broken when the airbag 45 starts to inflate is disposed in a region farther forward (to the tube main body 91 side) than the joining region 103 in which the temporary fastening tab 102 is joined to the winding fabric 100. In the case of the embodiment, as shown in FIG. 13, the breakable portion 104 is configured of a main slit 105, formed in a linear form following the left-right direction in the region on the front side (the tube main body 91 side), and two sub-slits 106, 106, formed on both left and right end sides on the rear side of the main slit 105. The main slit 105 is formed continuously in an approximately linear form approximately following the left-right direction, except on both left and right edge sides of the temporary fastening tab 102. The two sub-slits 106, 106 are formed in an approximately linear form in such a way as to extend one each from a left edge 102b and a right edge 102c of the temporary fastening tab 102 into a region coinciding with an end portion of the main slit 105 on a front-rear direction side (refer to FIG. 13). In the case of the embodiment, as shown in FIG. 13, a tube main body base fabric 110 configuring the tube main body 91 is configured by a warp VT being caused to approximately follow the front-rear direction. That is, the warp VT configuring the temporary fastening tab 102 is of a configuration divided in advance by the main slit 105 or the sub-slits 106, 106. Because of this, the temporary fastening tab 102 is broken by an unraveling being caused in such a way that the divided warp VT unravels from a weft HT between the main slit 105 and the sub-slits 106, 106 when the airbag 45 inflates, whereby the tube main body 91 can be caused to separate from the winding fabric 100. In the embodiment, the tube main body 91 and the temporary fastening tab 102 extending from the tube main body 91 are configured of the kind of tube main body base fabric 110 shown in FIG. 8. The tube main body 91 is such that a region of the gas rectifying portion 95 is of a tubular form owing to the tube main body base fabric 110 being folded in two and corresponding edge portions being joined (sewn) to each other.

Each of the attachment bracket 115 that attaches the attachment piece portions 70 (70L, 70R) to the bottom wall portion 21 of the case 20 includes the attachment plate 116, of an approximate rectangular plate form, and the attachment bolts 117 protruding downward from the attachment plate 116. An external form of the attachment plate 116 is an approximate rectangular plate form wherein a left-right direction side is wider, as indicated by a two-dot chain line in FIG. 6. Although a detailed depiction is omitted, two attachment bolts 117 are juxtaposed following the left-right direction. Each of the attachment bracket 115 is of a configuration that attaches the attachment piece portion 70 to the bottom wall portion 21 of the case 20 by the attachment bolts 117 protruding from the attachment piece portion 70 being caused to protrude from the bottom wall portion 21 of the case 20 and fastened with the nuts 119 (refer to FIG. 3).

Next, a mounting of the airbag device M of the embodiment in the vehicle V will be described. The inflator 30 is put into a state wherein the inflator main body 31 is caused to be held in the attachment bracket 35 using the clamps 40. Then, firstly, the inflator 30 is inserted into the attachment side portion 92 of the tube main body 91 in the inner tube 90 in such a way that the attachment bolts 39 are caused to protrude from the insertion holes 92c. Next, the winding material 100 is wound around the outer peripheral side of the inflator 30, including the tube main body 91, from the leading end 100b side, as shown in FIGS. 14A and 14B. Subsequently, a tape material 125, which is breakable when an inflating gas is discharged from the gas discharging unit 32 in the inflator main body 31, is wound around an outer peripheral side of the winding fabric 100 (refer to a two-dot chain line in FIG. 14B), thereby maintaining a state wherein the winding fabric 100 is wound around the outer peripheral side of the inflator 30 (the inflator main body 31). In the case of the embodiment, although a detailed depiction is omitted, the tape material 125 is wound around in two places, one on either end side of the winding fabric 100. Further, in the embodiment, the tube main body 91 is also wound around the outer peripheral side of the inflator 30 (the inflator main body 31), simultaneously with the winding fabric 100 being wound around the outer peripheral side of the inflator 30. At this time, a state wherein the tube main body 91 is wound around the outer peripheral side of the inflator 30 (the inflator main body 31) is maintained by the winding fabric 100, whose wound state is maintained by the tape material 125.

Next, the airbag 45 is folded in such a way as to be able to be housed in the case 20. Specifically, although a detailed depiction is omitted, the airbag 45 is folded in such a way as to be able to be housed in the case 20, in a state wherein a dummy inflator whose external form is approximately the same as that of the inflator 30 is housed in the interior in order to secure housing space for the inflator 30, in such a way that front-rear direction side and left-right direction side width dimensions are contracted from a state wherein the bag main body 46 is flattened in such a way that the pedestrian side wall portion 46b coincides with the vehicle body side wall portion 46a. Subsequently, a periphery of the folded airbag 45 (a completely folded body) is wrapped with a breakable, unshown wrapping material for preventing an unfolding. At this time, the insertion aperture portion 50 in the airbag 45 and a region of the attachment piece portions 70 are caused to be exposed in the wrapping material. Further, a region of the cover panel 54 of the insertion aperture portion 50 is opened, and the dummy inflator is removed from the completely folded body (the airbag 45) by being pulled out through the insertion slit 51. The inflator 30 in a state wherein the inner tube 90 is wound around the outer peripheral side as heretofore described is inserted into the completely folded body (the airbag 45) through the insertion slit 51. The attachment bolts 39 are caused to protrude from the insertion holes 52, thereby housing the inflator 30 in the interior of the airbag 45. Subsequently, the cover panel 54 is closed in such a way as to cover the insertion slit 51, and the attachment bolts 39 are inserted through the attachment holes 56 on the front end 54a side. Also, the attachment brackets 115 are attached to each attachment piece portions 70, thereby manufacturing an airbag assembly. Subsequently, the airbag assembly is housed in the case 20 in such a way as to cause the attachment bolts 39 and 117 to protrude from the bottom wall portion 21. The airbag 45 and the inflator 30 can be attached to the case 20 by the nuts 42 and 119 being fastened respectively on the attachment bolts 39 and 117 protruding from the bottom wall portion 21. Further, the airbag device M can be mounted in the vehicle V by attaching the airbag cover 25 to the case 20, and connecting the inflator main body 31 to an unshown operation circuit.

In the airbag device M of the embodiment, when an unshown operation circuit detects a collision between the vehicle V and a pedestrian based on a signal from an unshown sensor disposed in a front bumper 6, the inflator 30 is operated, an inflating gas is caused to flow into the interior, and the airbag 45 inflates. The inflating airbag 45 pushes open the door portion 26 of the airbag cover 25, and protrudes upward from the protrusion aperture 20a of the case 20 formed by the door portion 26 being pushed open. Further, the airbag 45 is such that inflation is completed in such a way as to cover a region from the upper face of the rear end 15c of the hood panel 15 to the upper face of the cowl 7, and the lower portion 5a sides of the front faces of the front pillars 5L and 5R (refer to FIGS. 15 and 16).

Further, although in the airbag device M of the embodiment, the outer peripheral side of the inflator main body 31 is covered with the inner tube 90, the inner tube 90 includes the tube main body 91, which causes an inflating gas to flow out rectified, and the winding fabric 100, whose width direction is set to be approximately the same as that of the tube main body 91. The tube main body 91 is inserted into the airbag 45 in a state wherein the winding fabric 100 is wound around the outer peripheral side, and a state wherein the tube main body 91 is wound around the outer peripheral side of the inflator main body 31 is maintained by the winding fabric 100. Because of this, in the airbag device M of the embodiment, the inflator 30 and the inner tube 90 are of compact external dimensions, and can easily be inserted through the insertion slit 51 (the insertion aperture) of the airbag 45. This is because the tube main body 91 wound around the periphery of the inflator main body 31 is covered with the winding fabric 100 over approximately the whole width direction area. Also, in the airbag device M of the embodiment, even when the attachment bolts 39 (the attachment members) protruding from the inflator main body 31 are caused to protrude from the peripheral edge (the insertion hole 52) of the insertion slit 51, a part (one portion) of the tube main body 91 can be restricted from becoming erroneously interposed (becoming jammed). This is because the tube main body 91 (specifically, the gas rectifying portion 95) is wound around the outer peripheral side of the inflator main body 31 in a wound state wherein jamming can be prevented by the winding fabric 100 covering the outer peripheral side. Because of this, an occurrence of the inner tube 90 becoming jammed in the peripheral edge region of the attachment bolts 39, or the like, when coupling to the case 20 acting as a housing region can be restricted. In particular, in the airbag device M of the embodiment, an insertion aperture formed in the airbag 45 in order to cause the inflator 30 to be inserted is the insertion slit 51 configured by forming a linear cut in the vehicle body side wall portion 46a. Also, the length dimension of the insertion slit 51 is set to be smaller than the length dimension of the inflator main body 31. The tube main body 91 wound around the periphery of the inflator main body 31 is such that an outer surface side of the gas rectifying portion 95, which is formed in such a way as to partially protrude, is covered over a whole area with the winding fabric 100. Because of this, unevenness of the tube main body 91 is not exposed on the surface side, and the inflator 30 in a state wherein the inner tube 90 is wound around can be inserted smoothly into the airbag 45 through the insertion slit 51, even when the length dimension of the insertion slit 51 is small.

Consequently, the airbag device M of the embodiment is such that the inflator 30 in a state wherein the outer peripheral side is covered with the inner tube 90 can be disposed smoothly in the interior of the airbag 45.

Also, in the airbag device M of the embodiment, a winding of the winding fabric 100 around the outer peripheral side of the inflator 30 is maintained using the breakable tape material 125. Further, when an inflating gas is discharged from the inflator main body 31, a winding around the outer peripheral side of the tube main body 91 is terminated by the tape material 125 being caused to break and can be unwound so that the gas outflow ports 96L and 96R are caused to open while the tube main body 91 is caused to separate from the attachment bolt 39 side. Because of this, the tube main body 91 is unaffected by the winding fabric 100 when the inflator 30 operates, and the inflating gas G can swiftly be caused to flow into the airbag 45 from the gas outflow ports 96L, 96R, and 98, whereby the airbag 45 can swiftly be caused to inflate.

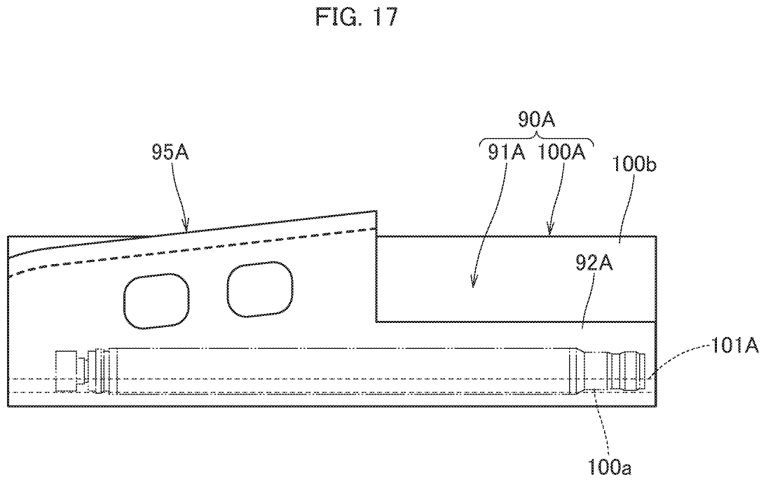

Furthermore, in the airbag device M of the embodiment, the tube main body 91 is such that one portion is coupled to the winding fabric 100 in such a way as to be detachable. Because of this, the tube main body 91 can be handled integrated with the winding fabric 100 when the winding fabric 100 is wound around the periphery of the inflator 30, and a winding operation is easy. When such a point is not taken into consideration, a kind of inner tube 90A shown in FIG. 17 may be used, as will be described hereafter.

Further still, in the airbag device M of the embodiment, the tube main body 91 and the winding fabric 100 are coupled via the temporary fastening tab 102, which has the breakable portion 104. Because of this, a coupling of the tube main body 91 and the winding fabric 100 can be terminated by the breakable portion 104 provided in the temporary fastening tab 102 being caused to break. As a result of this, damage to the tube main body 91 can be restricted from occurring when coupling is terminated, and there is no loss of a rectifying action by the tube main body 91. In particular, in the embodiment, the breakable portion 104 is configured by slits being intermittently formed in the temporary fastening tab 102. Specifically, the main slit 105 and the two sub-slits 106, 106 are formed as the breakable portion 104 in an intermediate region of the temporary fastening tab 102. The main slit 105 and the sub-slits 106, 106 are caused to deviate on a length direction side (a front-rear direction side, a side in a direction following a direction in which the winding fabric 100 is wound) of the temporary fastening tab 102, and are disposed in such a way as to partially coincide on a width direction side (a left-right direction side, a side in a direction perpendicular to the direction in which the winding fabric 100 is wound). Because of this, an unraveling can easily be caused to occur in a region between the main slit 105 and the sub-slits 106, 106, and a state of coupling created by the temporary fastening tab 102 can swiftly be terminated when the inflator 30 operates. A breakable portion provided in a temporary fastening tab is not limited to being intermittently provided slits. For example, a breakable portion may be configured by sewing using breakable suture thread, bonding using a peelable adhesive, or the like.

Further still, in the airbag device M of the embodiment, the temporary fastening tab 102 is disposed in such a way as to couple an end edge on a winding termination side (the leading end 100b) of the winding fabric 100 and the tube main body 91. Because of this, the tube main body 91 can also be simultaneously folded together with the winding fabric 100 when the winding fabric 100 is wound around the periphery of the inflator 30, an operation of folding the tube main body 91 independently is unnecessary, and an operation of winding of the winding fabric 100 and the tube main body 91 around the periphery of the inflator 30 is still easier. In particular, in the airbag device M of the embodiment, the width dimension on the front-rear direction side (an axial rotation direction side of the inflator main body 31) of the winding fabric 100 is set to be shorter than the width dimension on the front-rear direction side (the axial rotation direction side of the inflator main body 31) of a region on the left end 95a side of the gas rectifying portion 95 in the tube main body 91 in a flattened state. Further, the tube main body 91 is caused to slacken in a region on the left end 95a side of the gas rectifying portion 95 in a state wherein the temporary fastening tab 102 is joined to the leading end 100b side of the winding fabric 100. Because of this, the gas rectifying portion 95 of the tube main body 91 can be restricted from being disposed in a region on a lower face side, which is the attachment bolts 39 side, simply by the winding fabric 100 being wound around the outer peripheral side of the inflator 30 in such a way that the leading end 100b is oriented forward, and the gas rectifying portion 95 can be disposed in an upper side region when the inflator 30 is mounted in a vehicle.

In the embodiment, the temporary fastening tab 102 is formed integrated with the tube main body 91 in such a way as to extend from the tube main body 91 side. However, a temporary fastening tab may be formed integrated with a winding fabric in such a way as to be extended from the winding fabric side. Furthermore, a configuration may be such that a temporary fastening tab is a body separate to a tube main body and a winding fabric, and is caused to be coupled to each of the tube main body side and the winding fabric side by sewing using suture thread, or the like.

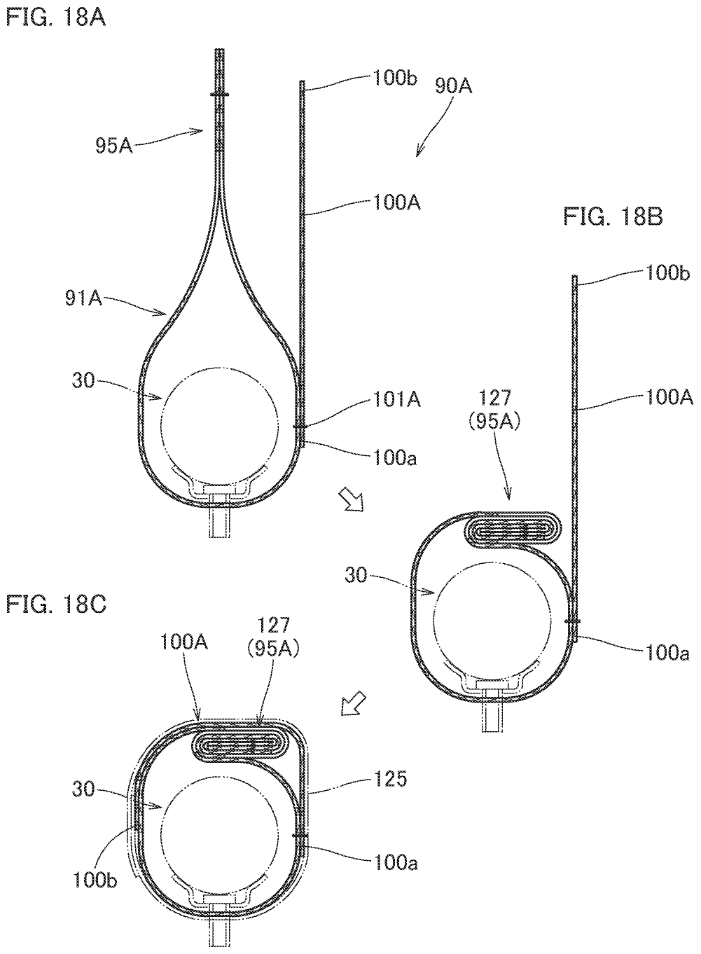

Also, an inner tube of a kind of configuration shown in FIG. 17 may be used as the inner tube 90A. Except for not including a temporary fastening tab, the inner tube 90A is of the same configuration as the inner tube 90. That is, the inner tube 90A is of a configuration wherein a winding fabric 100A is caused to be coupled to a tube main body 91A on only a base portion 100a side. When using this kind of inner tube 90A, firstly, in a state wherein the inflator 30 is inserted in an attachment side portion 92A of the tube main body 91A in the inner tube 90A, a gas rectifying portion 95A in the tube main body 91A is folded in such a way as to form a folded body 127, as shown in FIGS. 18A and 18B. Next, the winding fabric 100A is wound around the outer peripheral side of the inflator 30 from the leading end 100b side in such a way as to cover a periphery of the folded body 127, and the tape material 125 is wound around an outer peripheral side of the winding fabric 100A (refer to FIG. 18C). Further, a state wherein the tube main body 91A is wound around the outer peripheral side of the inflator 30 (the inflator main body 31) can be maintained by the winding fabric 100A, whose wound state is maintained by the tape material 125.

In the inner tubes 90 and 90A of the embodiment, the winding fabrics 100 and 100A are integrated by being sewn to the tube main bodies 91 and 91A on the base portion 100a side. However, a configuration may be such that a winding fabric is wound around a periphery of a tube main body as a separate body, rather than being integrated with the tube main body.

Also, in the embodiment, the description has been given employing a pedestrian airbag device as an example, but an airbag device to which the present disclosure can be applied is not limited to a pedestrian airbag device. For example, the present disclosure can also be applied to a side airbag device or the like, provided that a configuration is such that an inflator whose outer peripheral side is covered with an inner tube is housed in an airbag.

The present disclosure relates to an airbag device of the following configuration.

The airbag device includes an airbag, an inflator that can supply an inflating gas to the airbag, a housing region in which the folded airbag and the inflator are housed, and an inner tube that covers an outer peripheral side of the inflator in the airbag. The inflator includes an inflator main body of an approximately cylindrical form and an attachment member, disposed in such a way as to protrude from the inflator main body, for attaching the inflator to the housing region, and is of a configuration coupled to the housing region together with the airbag and the inner tube by, in a state inserted into an interior of the airbag through an insertion aperture formed in the airbag in a state wherein an outer peripheral side of at least a part (one portion) of the inflator main body is covered with the inner tube, the attachment member being caused to protrude from the airbag in a peripheral edge of the insertion aperture and coupled to the housing region. The inner tube is configured of a sheet material having flexibility, and includes a tube main body, of a configuration covering the outer peripheral side of the inflator main body, that has a gas outflow port that can cause the inflating gas to flow out rectified, and a winding fabric, configured in such a way that a width dimension is approximately the same as that of the tube main body, that is wound around an outer peripheral side of the tube main body in such a way that a state wherein the tube main body is wound around the outer peripheral side of the inflator main body can be maintained when an operation of inserting inside the airbag is carried out. The winding fabric is disposed in such a way that when the inflating gas is discharged from the inflator main body, a winding around the outer peripheral side of the tube main body is terminated and can be unwound so that the gas outflow port is caused to open while the tube main body is caused to be detached from the attachment member side.

Although in the airbag device of the present disclosure, the outer peripheral side of at least a part (one portion) of the inflator main body is covered with the inner tube, the inner tube includes the tube main body, which causes the inflating gas to flow out rectified, and the winding fabric, whose width direction is set to be approximately the same as that of the tube main body. The tube main body is inserted into the airbag in a state wherein the winding fabric is wound around the outer peripheral side, and a state wherein the tube main body is wound around the outer peripheral side of the inflator main body is maintained by the winding fabric. Because of this, in the airbag device of the present disclosure, the inflator and the inner tube are of compact external dimensions, and can easily be inserted through the insertion aperture of the airbag. This is because the tube main body wound around a periphery of the inflator main body is such that the outer peripheral side is covered with the winding fabric over approximately a whole width direction area. Also, in the airbag device of the present disclosure, even when the attachment member protruding from the inflator main body is caused to protrude from a peripheral edge of the insertion aperture, a part (one portion) of the tube main body can be restricted from becoming erroneously interposed (becoming jammed). This is because the tube main body is wound around the outer peripheral side of the inflator main body in a wound state wherein jamming can be prevented by the winding fabric covering the outer peripheral side. Therefore, an occurrence of the inner tube becoming jammed in a peripheral edge region of the attachment member, or the like, when coupling to the housing region can be restricted.

Consequently, the airbag device of the present disclosure is such that an inflator in a state wherein an outer peripheral side is covered with an inner tube can smoothly be disposed in an interior of an airbag.

Also, in the airbag device of the present disclosure, the winding fabric is configured in such a way that when the inflating gas is discharged from the inflator main body, a winding around the outer peripheral side of the tube main body is terminated and can be unwound so that a gas outflow port is caused to open while the tube main body is caused to be detached from the attachment member side. Because of this, the tube main body is unaffected by the winding fabric when the inflator operates, and the inflating gas can swiftly be caused to flow into the airbag from the gas outflow port, whereby the airbag can swiftly be caused to inflate.

Furthermore, in the airbag device of the present disclosure, it is preferable that the tube main body is configured in such a way that a part (one portion) is coupled to the winding fabric in such a way as to be detachable. When the airbag device is of this kind of configuration, the tube main body can be handled integrated with the winding fabric when the winding fabric is wound around the periphery of the inflator, and a winding operation is easy.

Further still, in the airbag device of the heretofore described configuration, it is preferable that the tube main body and the winding fabric are coupled via a temporary fastening tab that has a breakable portion. When the airbag device is of this kind of configuration, a coupling of the tube main body and the winding fabric can be terminated by the breakable portion provided in the temporary fastening tab being caused to break. Because of this, damage to the tube main body can be restricted from occurring when coupling is terminated, and there is no loss of a rectifying action by the tube main body.

Specifically, slits intermittently provided in the temporary fastening tab can be given as an example of a breakable portion.

Further still, in the airbag device of the heretofore described configuration, it is preferable that the temporary fastening tab is disposed in such a way as to couple an end edge on a winding termination side of the winding fabric and the tube main body. When the airbag device is of this kind of configuration, the tube main body can also be simultaneously folded together with the winding fabric when the winding fabric is wound around the periphery of the inflator, an operation of folding the tube main body independently is unnecessary, and an operation of winding around the periphery of the inflator is still easier.

Further still, the airbag device may be of a configuration wherein the tube main body is in a state of a folded body folded on a periphery of the inflator, and the winding fabric is disposed wound around a periphery of the folded body.

What is claimed is:

1. An airbag device, comprising:
an airbag;
an inflator that can supply an inflating gas to the airbag;
a housing region in which the folded airbag and the inflator are housed; and
an inner tube that covers an outer peripheral side of the inflator in the airbag, wherein
the inflator includes an inflator main body of an approximately cylindrical form and an attachment member, disposed in such a way as to protrude from the inflator main body, for attaching the inflator to the housing region, and is of a configuration coupled to the housing region together with the airbag and the inner tube by, in a state inserted into an interior of the airbag through an insertion aperture formed in the airbag in a state wherein an outer peripheral side of at least a part of the inflator main body is covered with the inner tube, the attachment member being caused to protrude from the airbag in a peripheral edge of the insertion aperture and coupled to the housing region,
the inner tube is configured of a sheet material having flexibility, and includes
a tube main body, of a configuration covering the outer peripheral side of the inflator main body, that has a gas outflow port that can cause the inflating gas to flow out rectified, and
a winding fabric, configured in such a way that a width dimension is approximately the same as that of the tube main body, that is wound around an outer peripheral side of the tube main body in such a way that a state wherein the tube main body is wound around the outer peripheral side of the inflator main body can be maintained when an operation of inserting inside the airbag is carried out, and
the winding fabric is disposed in such a way that when the inflating gas is discharged from the inflator main body, a winding around the outer peripheral side of the tube main body is terminated and is unwound so that the gas outflow port is caused to open while the tube main body is caused to be detached from the attachment member side.

2. The airbag device according to claim 1, wherein
a part of the tube main body is coupled to the winding fabric in such a way as to be detachable.

3. The airbag device according to claim 2, wherein
the tube main body and the winding fabric are coupled via a temporary fastening tab that has a breakable portion.

4. The airbag device according to claim 3, wherein
the breakable portion is configured of a slit intermittently provided in the temporary fastening tab.

5. The airbag device according to claim 4, wherein
a multiple of the slit are disposed, and are disposed in such a way as to deviate from each other on a length direction side of the temporary fastening tab, and to partially coincide on a width direction side of the temporary fastening tab.

6. The airbag device according to claim 3, wherein
the temporary fastening tab is disposed in such a way as to couple an end edge on a winding termination side of the winding fabric and the tube main body.

7. The airbag device according to claim 1, wherein
the tube main body is in a state of a folded body folded on a periphery of the inflator, and
the winding fabric is disposed wound around a periphery of the folded body.

8. The airbag device according to claim 1, wherein
the insertion aperture is configured of an insertion slit formed in a linear form approximately following an axial direction of the inflator main body in a wall portion configuring the airbag, and
a length dimension of the insertion slit is set to be smaller than a length dimension of the inflator main body.
